(19) United States
(12) Patent Application Publication
(10) Pub. No.: US 2007/0033632 A1
(43) Pub. Date: Feb. 8, 2007

(54) TEMPORAL DATA PREVIEWING SYSTEM

(75) Inventors: Michael Peter BAYNGER, Ottawa, ON (CA); Paul STREATCH, Richmond, ON (CA); Roger Francis MacLEAN, Nepean, ON (CA); Kenneth E. MAUGHAN, Nepean, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: MARCH NETWORKS CORPORATION, Ottawa (CA)

(21) Appl. No.: 11/458,570

(22) Filed: Jul. 19, 2006

Related U.S. Application Data
(60) Provisional application No. 60/700,324, filed on Jul. 19, 2005.

(51) Int. Cl. G06F 17/00; H04N 5/445; H04N 7/16; G06F 3/00

(52) U.S. Cl. 725/135; 348/563; 725/136; 715/500.1; 715/731

(57) ABSTRACT

A method and apparatus forming a user interface for examining and retrieving audio/video/data content from digital video recorders. This includes an improved time period selection mechanism, a rich array of temporal data presentations, such as timelines, lists, and thumbnail images, and a unified method of displaying content from either a direct stream or downloaded files. Summary information is provided relating to undownloaded content based on a selected time period.

### CROSS-REFERENCE TO RELATED APPLICATIONS

The present invention claims the benefit of U.S. Provisional Application No. 60/700,324 filed on Jul. 19, 2005, and is incorporated herein, in its entirety, by reference.

### FIELD OF THE INVENTION

The present invention relates generally to a method and system for viewing media content. More particularly, the present invention relates to a method and system for viewing and previewing media and/or data content from digital video recorders and other data storage means.

### BACKGROUND OF THE INVENTION

Existing user interface systems for locating and retrieving media (e.g., audio, video) content and other data content from remote servers are inefficient because they require the user to deal with and select from low level file storage mechanisms. Users are obliged to think in terms of data objects and file systems, as opposed to reviewing or previewing from a content perspective. For example, investigator users of digital video recorder systems are not looking for files, but for evidence. By forcing users to deal with the low level mechanics of the technology, existing systems impede the workflow and diminish the effectiveness of their users.

The ‘object oriented’ approach to implementing user interfaces for ‘subject oriented’ tasks has some drawbacks. Because data is broken into arbitrary and relatively meaningless segments in such file systems, a user must select a file before having a sense of its content. Also, a user may encounter difficulties when events of interest cross the boundary of given files. For example, if the user is attempting to find the point at which a vehicle enters a prohibited zone, a file oriented system forces the user to repeatedly select stored files and then search through thumbnails or play through the video to locate the time of the incident. This involves many steps and complex interaction sequences.

Some known content navigation approaches use a tree control as a way of navigating through both the spatial dimension (camera selection) and the temporal dimension (sub-branches of chronological file sequences). In terms of efficiency, the user must drill down through many layers to make a content selection. A significant amount of this interaction is redundant and therefore a waste of the user's time and energy. For example, to look at a set of thumbnails for Camera A at a given time and date the user must: first select at the camera level; then locate a date from a sub-branch; then locate a time from yet another sub-branch; and then request a thumbnail view. If the user then wants to examine thumbnails on Camera B, even for the same time period, the entire process must be repeated.

One known approach for retrieving media content uses a system for displaying storyboards of video sequences via thumbnail representations. The video sequences are determined by files selected from a video repository. Such systems are intended to be part of a content management system and are focused on the problem of viewing file contents over a limited bandwidth network.

Another known approach uses a timeline presentation of content. Generally, this view is available only after having previously selected a file. The steps taken to produce this timeline view of the file involve a search through the digital video recorder (DVR) contents based on date, time, camera, and optionally other criteria. At the point when this search is done, there is no preview data or content displayed, so the search is done blindly.

A further known approach uses a timeline of video motion detector (VMD) data to assist in selecting regions of interest. Once again this previewing capability is only available once the file has been loaded from the server into the client system.

Some known approaches separate the play position indicator/control from the data timeline. This makes it significantly harder to place the view position on the region of interest. Also, once the download has been committed, the scale of the playback timeline cannot be adjusted.

It is, therefore, desirable to provide a method and system, including a user interface, for previewing data from DVR's and associated storage and/or recording devices, that overcomes at least one of the drawbacks of known approaches.

### SUMMARY OF THE INVENTION

It is an object of the present invention to obviate or mitigate at least one disadvantage of previous user interfaces or previewing systems for accessing media or other data content, particularly from digital video recorders/servers.

The present invention allows users to more rapidly find meaningful content by hiding low level file system mechanisms and presenting content directly and understandably through an integrated arrangement of spatial and temporal controls. By eliminating the complexities brought on by an object oriented approach and instead presenting useful temporal data in a continuous and consistent manner, the present invention makes it significantly easier for the user to grasp the relationships between the various temporal events that, in turn, helps to find desired content.

In a first aspect of the present invention, there is provided a temporal data previewer for examining content from a digital content source. The previewer comprises a time period selector, a preview display module and a media presentation module. The time period selector selects a time period in which to preview temporal data. The preview display module presents temporal data associated with the selected time period. The media presentation module presents media content associated with the temporal data associated with the selected time period.

In embodiments of the first aspect of the present invention, the previewer includes a source selector for selecting the digital content source for the temporal data, which can be optionally selected from a group consisting of a digital video source, a digital audio source, event marker sources and transaction data sources. In other embodiments, wherein the preview display module includes a timeline interface, the previewer can include time period selection controls and time scale resolution controls for scaling the timeline interface to correspond to the selected time period. The preview display module can include means for presenting summary information, such as thumbnail images, activity data, and data coverage. The media presentation can include means for displaying at least one of video stream data, audio stream data, transaction data and event data. In addition, the previewer can include means for displaying auxiliary data, from an auxiliary source, associated with the selected time period.

In a further aspect, the present invention provides a method of examining and retrieving content from a digital video source using a temporal data previewer. The method comprises steps of presenting temporal data for a selected time period; selecting a time interval in the selected time period; and displaying content associated with the selected time interval. According to embodiments of the method, the method can include selecting a digital content source for the temporal data, such as a digital video source, a digital audio source, event marker sources and transaction data sources. Temporal data can be displayed on a timeline interface, including such time period selection controls and/or time scale resolution controls for scaling the timeline interface to correspond to the selected time period. The method can also include presenting summary information, such as thumbnail images, activity data, and data coverage. Displaying the content associated with the selected time interval can include displaying at least one of video stream data, audio stream data, transaction data and event data, and can further include displaying auxiliary data, from an auxiliary source, associated with the selected time period.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures, wherein:

FIG. 1 illustrates components of a user interface system for a temporal data previewer according to an embodiment of the present invention;

FIG. 2 is a screenshot of a user interface system for a temporal data previewer according to an embodiment of the present invention;

FIG. 3 is a flow diagram illustrating steps in a method for browsing for content on a time and location basis according to an embodiment of the present invention;

FIG. 4 is a flow diagram illustrating how the additional data, which is derived from a search operation, can be used in a method for browsing for content on a time and location basis according to an embodiment of the present invention; and

FIG. 5 illustrates components of a user interface system for a temporal data previewer according to an embodiment of the present invention incorporating a preliminary auxiliary search function.

### DETAILED DESCRIPTION

Generally, the present invention provides a method, system, and user interface for examining and retrieving content from DVR's, and associated devices. The content can include, for example, video, audio, transaction and other data. The present invention uses an improved time period selection mechanism, a rich array of temporal data presentations (e.g., timelines, lists, thumbnail images . . . etc.) and a unified method of displaying content from either a direct stream or downloaded files. Summary information can be provided, relating to content within a selected time period. The present invention is intended for use with a DVR or server, such as used for surveillance, security, closed circuit television (CCTV) and similar applications or combinations thereof.

As used herein, temporal data is any time-related content or information, video or otherwise, captured in systems, such as video surveillance or DVR systems, or auxiliary systems associated therewith. Of particular interest in the context of the present invention is temporal data related to temporal events. Temporal events can include any event that can be detected and associated with a timestamp or other means of locating the information in time. Temporal events can include, for example, detected motion, detected audio, transactional events, and alarm events. The temporal data associated with such temporal events can include, for example, video streams from one or more cameras; audio streams; transaction data, such as credit card information, withdrawal or charge amounts, and receipt images; alarm types and locations; Global Positioning Satellite (GPS) information; or any other data that can be collected in relation to an event of interest. The above examples are not intended to be limiting in any way, and the present invention can be used to preview and select any temporal event and its associated temporal data within the context of a DVR system.

The present invention uses a continuous and simplified time period selection system. Summary data can be automatically presented for a selected time period without explicit file loading or segmentation. There is strong mapping of temporal data to the time period selector providing a clear, spatial image to determine if, and where, meaningful content exists. Whereas other systems impose arbitrary file segmentation of the raw content and force the user to deal with the mechanics of the storage system (i.e., they are ‘object oriented’), the system of the present invention focuses on the value of the content and allows users to fluidly examine still images or video sequences, whether they are resident on the DVR or have been downloaded to local files, all through a single unified user interface. The system does not force the user to read through lists of meaningless (i.e., non-intuitive to a user) file names that have been automatically generated by the DVR's internal storage management system. The system can clearly show where in a given time period, and along a displayed timeline, temporal event data exists and where it does not, regardless of the underlying file system. This permits the creation of a single temporal space where the user can also view other supporting temporal data that can greatly assist the user in determining which video is likely to be of interest (e.g., VMD levels, event markers, etc.).

In a system according to an embodiment of the present invention, temporal and spatial content and viewing mechanisms are integrated. Thus, once a user has selected a time of interest, switching to another camera can be achieved by selecting the other camera, such as by a single click in a separate camera selector. This is especially beneficial when investigators desire to review an incident from multiple angles, because they do not need to specify the same time period repeatedly.

Embodiments of the present invention preferably seamlessly integrate data previewing, segment marking, and playback position for both direct streaming and playback of downloaded material. As such, there is a continuous and consistently simple method for handling time navigation.

In the following description, for purposes of explanation, numerous details are set forth in order to provide a thorough understanding of the present invention. However, it will be apparent to one skilled in the art that these specific details are not required in order to practice the present invention. Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

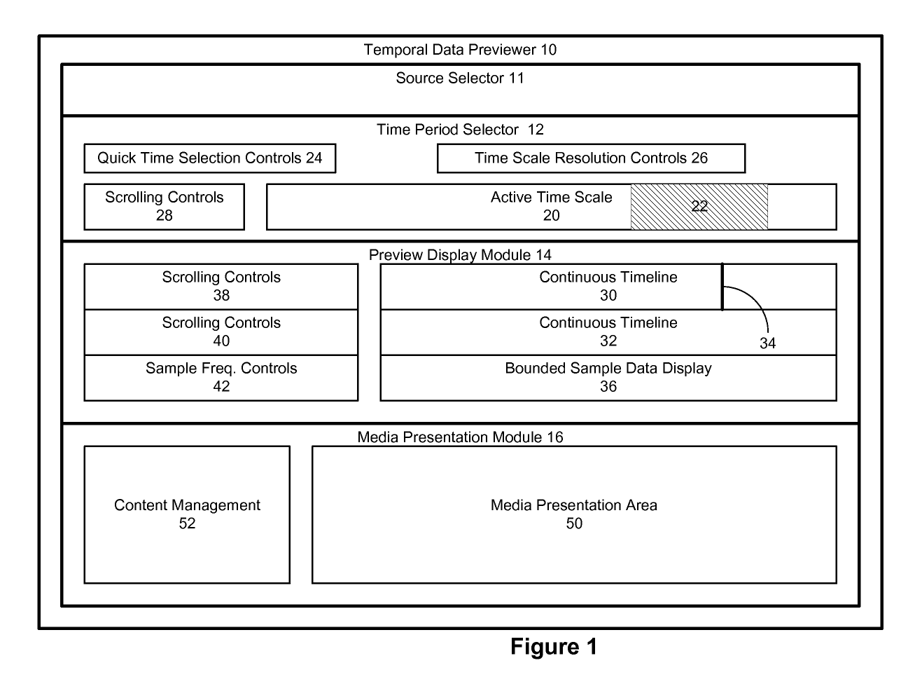

FIG. 1 illustrates components of a user interface of a temporal data previewer 10 according to an embodiment of the present invention. In its most basic form, used for time and location browsing, the temporal data previewer 10 of the present invention includes a source selector 11, a time period selector 12, a preview display module 14, and a media presentation module 16.

The source selector 11 allows a user to select, for example, one or more cameras from which to preview data. In a preferred embodiment, a picklist of cameras is provided and multiple camera angles are displayed, allowing selection by camera name or directly by selecting a camera angle view.

The time period selector 12 determines a time period in which to preview data for the selected content source(s). The time period selector 12 generally includes computer-readable instructions to provide one or more of the following: time period selection controls 24; time scale resolution controls 26; scrolling controls 28; a displayed time period 19, and a linked active time scale display 20. The time period selector 12 presents time as a continuum on a timeline. The time continuum can be viewed through multiple scales or time resolutions. The user simply adjusts the displayed time period to the desired or requested time period. Adjusting the time scale 20 will automatically adjust the time period displayed and vice versa. Typically, only one scale is presented at a time. In an embodiment, a plurality of scales can be presented in parallel. The scale that is active can be set via external mechanisms such as buttons or internally through mouse interactions. Other buttons or common interfaces, such as drop down menus and scroll bars, can be provided to allow the user convenient ways to adjust the time period to particular settings. In an embodiment, a ‘last hour’ button is provided to quickly configure the control to select the last sixty minutes. A calendar control can also be provided to allow the user to select one or more days via a more familiar metaphor.

The active time period is determined by highlighting, or otherwise selecting, section 22 on the scale. If a user selects a given month on a ‘year of months’ scale, then the corresponding cell will be highlighted. If the user shows the ‘month of days’ scale, then all the day cells for the given month will be highlighted. The finer resolution scales will show increasing numbers of cells to indicate the entire block of time that is selected. The user can ‘drill down’ in the scales and select only the cell or cells that really need to be examined. For example a user might select a day on the adjacent calendar control and then select just the hours that they want to examine on the ‘day of hours’ scale. The user can subsequently drill down to finer increments. If the user wants to get a broader picture of the data, it is possible to ‘drill up’. In this case the broader scales highlight the cells that are implicitly selected by the selection that was made at the finer resolutions.

The preview display module 14 displays one or more timelines 30, 32 for presenting temporal data. A time point position indicator 34 and a means of selecting sub-segments are also, preferably, provided. Generally, the preview display module 14 includes computer-readable instructions to provide the one or more continuous timelines 30, 32, scrolling controls 38, 40 for the continuous timeline(s), a bounded sample data display 36; and optional sample frequency controls 42.

The preview display module 14 also includes computer-readable instructions to permit it to communicate with a database, or other repository, of temporal data, and can retrieve such data, based on relevant timestamps or other time indicators, for display within the user interface, or for otherwise presenting the temporal data to the user (i.e. audio data). The timelines can be either continuous (i.e., can scroll forward or backward in time) or bounded (i.e., restricted to the given time period selected in time period selector 12). In an embodiment, there is a ‘recorded data’ timeline that shows where temporal data exists in time in the DVR's repository. There can also be a video motion timeline that indicates levels of video motion as a histogram, or shows other intensity, volume or activity levels related to other temporal events. There can also be an optional bounded sample data display 36 that provides an overview of the content within the selected time period. The bounded sample data display can, for example, show thumbnails of still images from video stored for the selected time period. In an embodiment, the first two timelines 30, 32 are continuous and the sample data is bounded.

The continuous timelines 30, 32 can present the time point indicator 34 as a vertical stripe, or by another indicator. The user can click a pointer or selector, such as a mouse pointer, on the timeline to set the current time point. Setting the time point indicator 34 can be achieved by any known cursor positioning means, such as keyboard control, hot keys, mouse or trackball activation. Whenever the time point is repositioned, a request can be automatically made to the DVR, database, or other data repository, for the nearest temporal data to that time, such as a still image, for display within the media presentation module 16.

The user can also select an area of the timeline 30 (e.g., by dragging the mouse pointer across it or by clicking on one or more thumbnails) for the purpose of refining the time period, playing live-streamed images, or downloading the data into a local video clip file. Such refinements will be reflected in the time period selector 12.

The media presentation module 16 includes computer-readable instructions to provide a media presentation area 50, such as a video display window, and various helper controls for adjusting presentation settings, offering feedback on play position time, playback controls and various other commonly known features. Media presentation module 16 also preferably provides a content management panel 52 to permit a user to save and annotate data previewed in the system. In an embodiment, when a time point only is selected in the preview area 14, the video display window in the media presentation area 50 shows the still image for that time. When the ‘play’ button is pressed, the system preferably requests relevant content, such as one or more still images from the DVR, and presents them sequentially in time. The user can optionally adjust the speed of the playback. The playback process continues while there is still material to retrieve from the DVR and the time point indicator on the preview timelines will update accordingly. If a segment or region of interest is highlighted on the preview timelines, then the playback can be restricted to that area.

The user can either click on time points on the preview timelines 30, 32 to examine temporal data, or can play sequences from any given point. When the user has found something that is of interest, the user can press a button or make a similar requesting action to download either the still image, the highlighted segment of video or other temporal data. For each download an entry is made in the content management panel 52. In an embodiment, this item is a textual item that can be linked to a specific point in a video clip and can be edited to capture the operator's thoughts or notes about why the item is useful. The list of linked items represents the file objects that have been created and saved to the user's local machine.

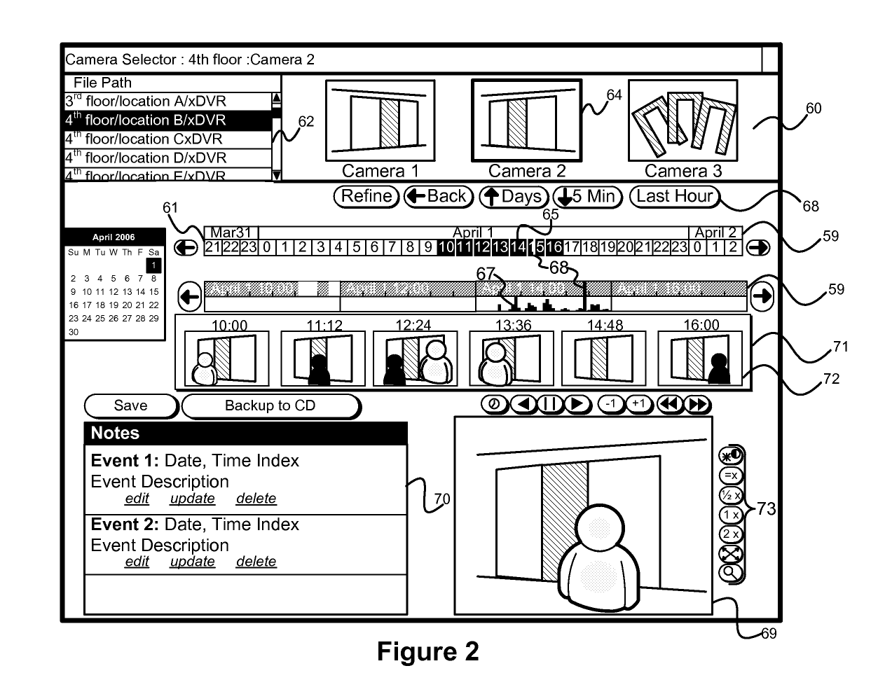

With reference to FIG. 2, which presents an exemplary user interface for a temporal data previewer according to an embodiment of the present invention, the operation of the present invention will now be described. A time and location browsing mode is shown. A camera selector 60 is provided that permits a user to switch between cameras, either through the picklist 62, or by selecting a camera angle thumbnail 64. In this example, the user has selected “Camera 2”, and data from that camera will be previewed. The time period 19 and active time scale 20 are depicted showing a single day (April 1) and a twenty-four hour time scale, respectively. The selected time period, as shown by the highlighted portion 65, is 10:00 to 16:00. Time period selection controls 58 are also provided to navigate within the time period. A first timeline 63, displays the selected time period, and shows where, within the selected time period, recorded data exists. The indication of the existence of recorded data, or data coverage, can be shown as, for example, contrasting or highlighted sections of the timeline, and indicates where video or other temporal data is stored on within the DVR or other data repository. A second timeline 66 is shown that indicates a level of video motion activity, through a histogram 67, within the selected time period. A time position indicator 68 is also shown. The time position indicator 68 determines the still image to be shown in the media display window 69. A content management panel 70 is provided at the bottom left and shows a single entry for a video clip, that is not currently being displayed. Selecting this clip entry would redisplay the clip in the media display window 69, and would position the controls to point to its corresponding time and location on the timelines 63 and 66. Playback controls 73 are also provided to allow playback of video streams within the media presentation window 69, in accordance with the selected time period, or an otherwise selected video or media clip.

As will be noted, the temporal data previewer in the example of FIG. 2 provides various types of summary information in the timelines 63 and 66, and in the preview area 71. This summary information includes the histogram 67, the still images 72 shown in the preview area 71, and the recorded data coverage information in the first timeline 63. In other embodiments of the present invention, summary information could be displayed elsewhere, depending on its content and type. This rich information display allows a user to quickly find and narrow in on relevant time periods where information of interest may exist.

To acquire and provide summary information generally requires client acquisition of summary information; and storage and retrieval of summary information. One approach is to use a file structure in which time and date information is embedded into the file/folder naming convention. This facilitates determination of the existence of data related to a temporal event of interest in a particular time period. A DVR can support commands to retrieve video thumbnails, media coverage (i.e. where recording exists), video activity data or other summary information depending on the temporal data of interest. Other data summarizations are possible, such as audio energy levels, vehicle speeds, alarm conditions, and transaction activity or amount, with analogous techniques. Furthermore, summary information can be decoupled from the location of the recordings. For example, one could upload summary information periodically to a server if connections to the media repository were somehow restricted (e.g., slow, or expensive, at certain hours), or a DVR may retain summary information for data that is offline (e.g., backed up on tape).

The temporal data, and summary information, such as thumbnails and video activity are stored to appropriate storage media, such as to files on disk. Each file can contain data for a range of time. Periodically, a new file can be started so that the DVR, or other data recorder can delete old content, to make space for new recordings. To make it possible to locate the file that contains data for a given time, the files are preferably stored in directories named according to the year, month and day and the files themselves have names that include the starting and ending timestamp for the data.

When summary information is required for a time period, the preview module or time period selector can send commands to the DVR to obtain it. The temporal data previewer then displays the results in the user interface as it receives it. Data can be sent incrementally if the summary information covers a large period (e.g., a week). It is desirable that summary information be retrievable as quickly as possible to improve the user experience.

The number of thumbnails or other summary information retrieved for a time period may be a user preference based on available bandwidth, screen size, etc. Requests for summary information, such as thumbnails, can be made based on the selected time period. To find a thumbnail, the DVR determines the location of the directory and locates the proper file using the start and end times encoded in the file names. The appropriate thumbnail can then be retrieved from the file. In the example shown in FIG. 2, seven thumbnails 72 are retrieved. The preview module requests the thumbnails for the start and end time of the selected time period, and evenly spaced thumbnails between the starting and ending thumbnails. If no thumbnail is available for the desired period (e.g., no recording exists at that time), an appropriate icon can be displayed. Otherwise, the thumbnails are shown on the user interface as they are received from the DVR.

Media coverage or existence information is requested for the time period displayed on the timeline. To determine video coverage for a period of time, the DVR searches for files covering that time period in the same manner as for finding files containing video activity data. However, in the case of video coverage, the contents of the files are ignored and instead the range of time ranges indicated by the file names is used as an indication of where there is data. In the example shown, the DVR provides a value between 0 (no recording) to 1 (complete coverage) for intervals of n seconds between the start and end times (the “bucket size”). For example, the preview module could request 240 buckets for a one hour period, which would equal a bucket every 15 seconds. Each bucket would be represented as a bar on the timeline 63, and the number of buckets equals the number of bars. Coverage may be indicated by the height of the bar (0 pixels to full height in the recorded data area for 0->1), color, intensity, etc. This information relays to the user whether there is any media content available in the given time frame, and can also indicate whether there is complete or incomplete coverage.

Temporal data, such as video activity information, can be requested similarly to media coverage, with a bucket size and results from 0 (no activity) to 1 (high activity). In the example shown, the activity values of 0 to 1 are mapped to bars of 0 height to full height of the timeline 66. As the requests are for video activity over a range of time, the DVR has to locate all the files that fall within a given time range. The procedure to locate these files is much the same as finding the file containing a thumbnail except that the DVR may have to look in multiple directories. Having found the files, the DVR examines information relating to each file in ascending order of time and reads out the video activity data. Rather than returning all the video activity data for a time period, the DVR can divide the time period into a limited number of bins (100 bins, for example) and, for each bin, return the maximum amount of activity during the time range covered by that bin.

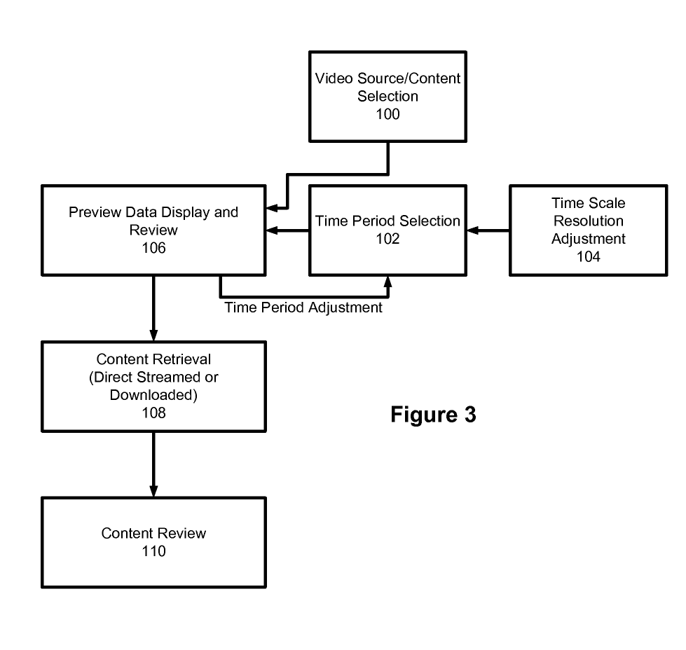

FIG. 3 is a flow diagram illustrating steps in a method for browsing for content on a time and location basis according to an embodiment of the present invention. The selection of a video source/camera (100) is important in order to identify what must be previewed and examined. The selection is typically performed by the user, but can be automatic if only one video source is available or if dictated by a predefined selection. The user can optionally adjust the time period control (102), since it always has some valid setting. Likewise the user can optionally adjust the time resolution (104) that is displayed, since the time period selector always has a valid scale. Once the user has determined the video source, the system can retrieve data from the DVR and present it (106) in the preview display area. Content associated with the selected time period can then be retrieved (108), and displayed in the media presentation area, where it can be reviewed (110) by the user. At any point in time the user can adjust either the video source selection or the time period selection without either adjustment interfering with the other settings.

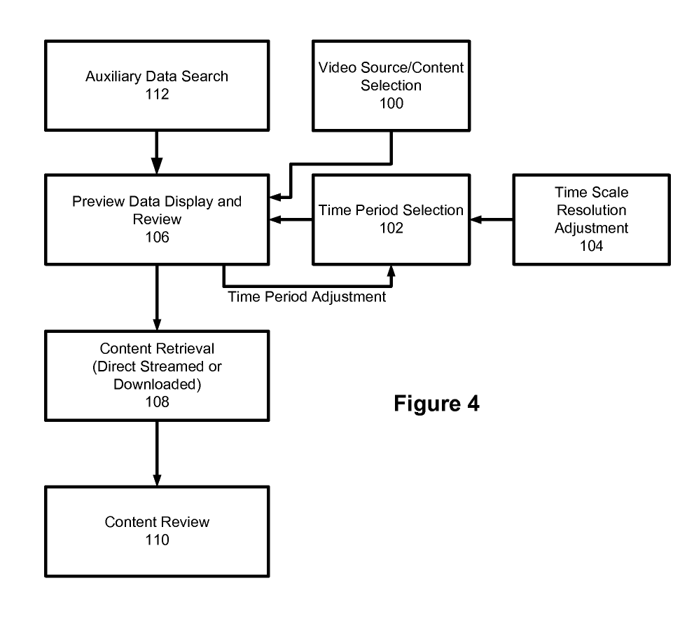

The user can also incorporate auxiliary temporal data from sources remote from the DVR, as an independent investigative tool or as a guide for doing the time and location browsing. FIG. 4 is a flow diagram illustrating how the auxiliary temporal data, which is derived from a search operation, can be used in a method for browsing for content on a time and location basis according to an embodiment of the present invention. The user begins by setting the auxiliary data search criteria (112). This might be as simple as choosing one or more alarm inputs, or it may be more complex and require more parametric inputs. An example of the latter is a search for banking transactions that match certain criteria such as transaction amount or account number. The output of an auxiliary data search is a set of discrete events that can be presented either spatially in the timelines or in tabular form.

Selecting an event item will drive the time and location mechanisms previously described to position the system to the correct video or other temporal data source, time period and highlighted region of interest. The corresponding temporal data for the given event will again be automatically presented for review by the user by mapping the camera to the auxiliary input source timestamps and event identifiers. From this point on the user can optionally treat the system as a time and location browser; or, the user can work from the event cues directly to identify and save content of interest.

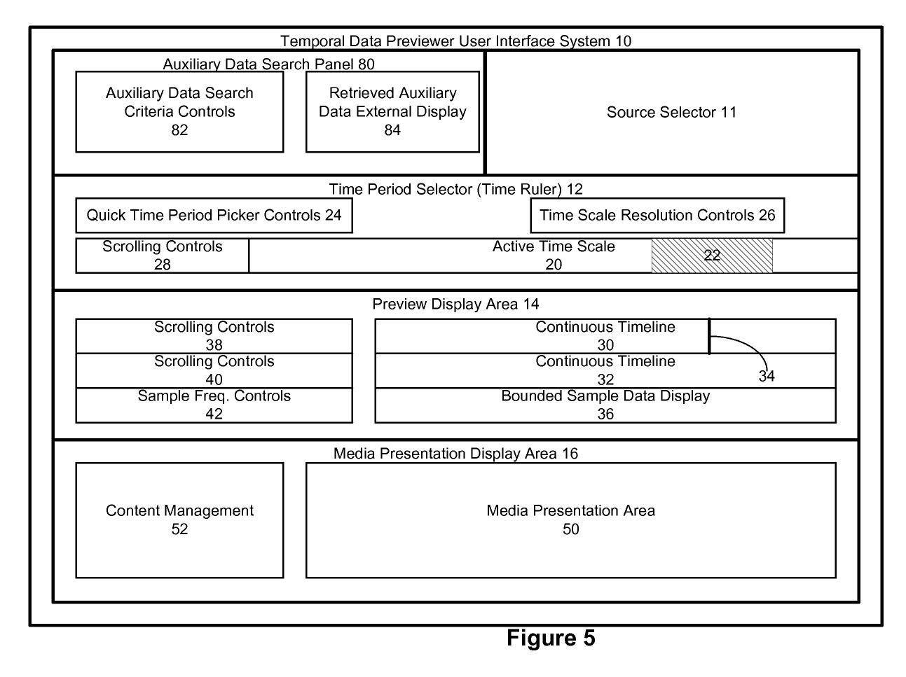

FIG. 5 illustrates components of a temporal data previewer according to an embodiment of the present invention incorporating a preliminary auxiliary search function, as described above in relation to FIG. 4. The temporal data previewer of FIG. 5 includes an auxiliary data search module 80, preferably including auxiliary data search criteria controls 82, and an area or panel for retrieved auxiliary data external display 84. The remaining components of the interface are as described in relation to FIG. 1.

The system of the present invention can also be used in tandem with or incorporating other supporting temporal data display mechanisms such as video analytic graphs, statistical data, business summary data, geographical maps, etc. Through similar applications of this system, one could control the time period aperture to drive such alternate preview displays in appropriate ways.

The present invention allows users to more rapidly find meaningful content by hiding low level file system mechanisms and presenting content directly and understandably in a more intuitive manner through an integrated arrangement of spatial and temporal controls. By eliminating the complexities brought on by an object oriented approach and instead presenting useful temporal data in a continuous and consistent manner, embodiments of the present invention make it significantly easier for the user to grasp the relationships between the various temporal events that, in turn, help to find desired content.

A user can initiate a binary search, or bracketed search, to zero in on a desired time point or time period, such as by pointing to places on a timeline. Users can typically find desired content more quickly than they could using conventional methods of sifting through files in a file system, and then shifting back to navigate through a playback system. In a system according to an embodiment of the present invention, the user can also view thumbnails displayed to show a temporal overview of the content for a given time period. By refining the aperture of the time period, desired content can be found with little effort or complexity. Efficiencies gained by using a system according to an embodiment of the present invention can make a significant impact on the success rate and productivity of investigation users.

The present invention provides a time continuum-based time period selector. This time navigation system treats all viewing and selection of time periods in a single consistent manner. The time navigation is capable of displaying time on different time scales, such as years, months, days, hours, minutes, etc. The user is able to quickly ‘zoom in’ to fine scale or ‘zoom out’ to broader scale without losing any existing time period selection or play position locations. The user can also switch to different content sources having to re-select time periods of interest. Furthermore, any time that can be represented by the digital clock within the computer system can be represented in this fluid manner. Time scales can be extended to include broader time resolutions or finer ones than those described and illustrated herein.

Preview timelines are also provided according to embodiments of the present invention. The timelines can include summary information or supporting data, graphically illustrating interrelationships between content and other material. This can greatly assist the user in locating meaningful content. It can also be a means of refining and adjusting the time period selection, as well as a means of controlling playback and downloading material to a local machine.

Direct streaming of temporal data from the DVR is also provided according to embodiments of the present invention, as data is requested from the DVR on the basis of time parameters and not via requests for specific files. This permits retrieval of both supporting data (such as video motion levels) and primary content (either still images or audio video sequences) through a simple action, such as clicking or swiping, on a timeline.

In summary, the present invention allows users to more rapidly find meaningful content by completely hiding low level file system mechanisms and presenting content directly and understandably through an integrated arrangement of spatial and temporal controls. By eliminating the complexities brought on by an object oriented approach and instead presenting useful temporal data in a continuous, more intuitive, and consistent manner, embodiments of the present invention make it significantly easier for the user to grasp the relationships between the various temporal events that in turn helps to find the desired content.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A temporal data previewer for examining content from a digital content source, comprising:
a time period selector for selecting a time period in which to preview temporal data;
a preview display module for presenting temporal data associated with the selected time period; and
a media presentation module for presenting media content associated with the temporal data associated with the selected time period.

2. The temporal data previewer as claimed in claim 1 further including a source selector for selecting the digital content source for the temporal data.

3. The temporal data previewer as claimed in claim 2 wherein the digital content source is selected from a group consisting of a digital video source, a digital audio source, event marker sources and transaction data sources.

4. The temporal data previewer as claimed in claim 1 wherein the preview display module includes a timeline interface.

5. The temporal data previewer as claimed in claim 4 wherein the timeline interface includes time period selection controls.

6. The temporal data previewer as claimed in claim 4 wherein the time period selector includes time scale resolution controls for scaling the timeline interface to correspond to the selected time period.

7. The temporal data previewer as claimed in claim 1 wherein the preview display module includes means for presenting summary information.

8. The temporal data previewer as claimed in claim 7 wherein the summary information includes thumbnail images, activity data, or data coverage.

9. The temporal data previewer as claimed in claim 1 wherein said media presentation module includes means for displaying at least one of video stream data, audio stream data, transaction data and event data.

10. The temporal data previewer as claimed in claim 1 further comprising means for displaying auxiliary data, from an auxiliary source, associated with the selected time period.

11. A method of examining and retrieving content from a digital video source using a temporal data previewer, said method comprising:
presenting temporal data for a selected time period;
selecting a time interval in the selected time period; and
displaying content associated with the selected time interval.

12. The method of claim 11 further including selecting a digital content source for the temporal data.

13. The method of claim 12 wherein the digital source is selected from a group consisting of a digital video source, a digital audio source, event marker sources and transaction data sources.

14. The method of claim 11 wherein presenting temporal data includes displaying a timeline interface.

15. The method of claim 14 wherein the timeline interface includes time period selection controls.

16. The method of claim 14 wherein presenting temporal data includes providing time scale resolution controls for scaling the timeline interface to correspond to the selected time period.

17. The method of claim 11 wherein the step of presenting temporal data includes presenting summary information.

18. The method of claim 17 wherein the summary information includes thumbnail images, activity data, or data coverage.

19. The method of claim 11 wherein displaying the content associated with the selected time interval includes displaying at least one of video stream data, audio stream data, transaction data and event data.

20. The method of claim 11 further comprising displaying auxiliary data, from an auxiliary source, associated with the selected time period.
